(19) United States
(12) Patent Application Publication
(10) Pub. No.: US 2010/0026157 A1
(43) Pub. Date: Feb. 4, 2010

(54) LAMP AND LIGHTING EQUIPMENT

(75) Inventors: Toshiya Tanaka, Yokohama-shi (JP); Takeshi Hisayasu, Tokyo (JP); Shigeru Osawa, Yokohama-shi (JP)

Correspondence Address: DARBY & DARBY P.C., P.O. BOX 770, Church Street Station, New York, NY, 10008-0770, US

(73) Assignee: Toshiba Lighting & Technology Corporation, Yokosuka-shi (JP)

(21) Appl. No.: 12/511,479

(22) Filed: Jul. 29, 2009

(30) Foreign Application Priority Data
Jul. 30, 2008 (JP) 2008-196678
Nov. 28, 2008 (JP) 2008-303794

(51) Int. Cl. H01J 61/52

(52) U.S. Cl. 313/45

(57) ABSTRACT

A plurality of LEDs are provided to an outer edge side of a center position of one main surface of an LED substrate main body in a deviated manner respectively. The wiring part including the connector receiving part and the wiring hole are provided at a position that overlaps the center position of the one main surface side of the LED substrate main body. Since the power feeding part is inserted into the wiring hole, the connection part and the connector receiving part can be easily connected and therefore it becomes possible to ensure ease in assembly. Since the connector receiving part is kept away from each of the LEDs with substantially equal distance so that emitted light is hardly blocked, decrease in uniformity of light distribution can be suppressed.

### INCORPORATION BY REFERENCE

The present invention claims priority under 35 U.S.C. §119 to Japanese Patent Application Nos. 2008-196678 and 2008-303794 filed on Jul. 30, 2008 and Nov. 28, 2008, respectively. The contents of these applications are incorporated herein by reference in their entirety.

### BACKGROUND OF THE RELATED ART

1. Field of the Invention

The present invention relates to a lamp and lighting equipment including an element substrate on which a plurality of light emitting elements are provided.

2. Background of the Invention

Conventionally, in an LED lamp which is a lamp using an LED as a light emitting element, an LED substrate which is an element substrate mounting LEDs equally on an outer circumference edge portion of the substrate is attached to one edge side of a heat radiation part and a globe is attached to the one edge side of the heat radiation part covering the LED substrate as shown in, for example, Japanese Laid-Open Patent Publication No. 2006-313718. Moreover, in another edge portion of the heat radiation part, a storage case storing a lighting device controlling lighting of the LED substrate is inserted and a cap is attached to a side opposite to a heat radiation part of the storage case.

In a case where the lighting device and the LED substrate are connected, it is preferable that a power feeder led out from the lighting device side is connected to the LED substrate side, taking ease in assembly into consideration. Moreover, taking connectivity of the power feeder into consideration, it is preferable that a connector portion is provided on an end side of the power feeder so that the power feeder can be connected to a connector board on the LED substrate side.

However, such a self-ballasted lamp has a problem that is decreased because the connector board blocks emission from the LED.

The present invention has been made in consideration of such a problem and is aimed at providing a lamp and lighting equipment which suppresses a decrease in light distribution uniformity while ensuring ease in assembly.

### SUMMARY OF THE INVENTION

The present invention includes an element substrate including; an element substrate main body, a plurality of light emitting elements provided at positions deviating to an outer edge side from a center position of one main surface of the element substrate main body, and a wiring part having a connection receiving part electrically connected to the light emitting elements and a wiring hole which is formed adjacent to the connection receiving part and is penetrating through the element substrate main body which is provided in a manner that at least a part thereof overlaps the center position of the one main surface side of the element substrate main body; a radiator having one edge side which is attached to the other main surface side of the element substrate main body of the element substrate while being in close contact with the other main surface side; a cap attached to the other edge side of the radiator; and a lighting device stored between the radiator and the cap which includes a power feeder and a connection part connected to a distal end of the power feeder to be connected to the connection receiving part and a power feeding part which can be inserted into the wiring hole for controlling lighting of the light emitting element.

In the present invention, the lamp may include a self-ballasted lamp which is caused to approximate the shape of a general incandescent light bulb (A type), a lamp of a reflection type lamp (R type), a lamp having a globular shape (G type), a lamp having a cylindrical lamp (T type) or the like. Moreover, the lamp may include a globe-less lamp type lamp. Further, the present invention is not limited to one that approximates a general incandescent light bulb and can be applied to a lamp having other various appearance configurations or usage.

The element substrate main body is made of a metal such as aluminum excellent in good radiation performance or the like.

As the light emitting element, a light emitting element having a semi-conductor or the like as a light source such as a light emitting diode (LED), an organic EL, or a semi-conductor laser may be used. The number of light emitting elements required is selected depending on the usage of the light. Although it is preferable that the light emitting element is configured to emit white light, the element may be configured to emit red, blue, green, or other light depending on the usage of the lighting equipment or may be configured to emit a color which is a combination of various colors.

At least a part of the wiring part is provided at a position that overlaps the center position of one main surface side of the element substrate main body means that, for example, a part of either the connection receiving part or the wiring hole overlaps the center position of the one surface side of the element substrate main body or an area between the connection receiving part and the wiring hole overlaps the center position of the one surface side of the element substrate main body.

The connection receiving part may include a mechanical retention unit such as a connector receiving part, or may be electrically connected by insertion of a power feeder like a terminal block.

The power feeding part may have a connection part connected to a connector receiving part at a distal end of the power feeder in a case where the connection receiving part includes a mechanical retention unit such as the connector receiving part, and in a case where the connection receiving part is a terminal block or the like, a distal end of a power feeder inserted into the terminal block may be the connection portion.

It is preferable that the radiator is formed of a metal including at least one of, for example, aluminum (Al), copper (Cu), iron (Fe), and nickel (Ni) having good heat radiation performance. Other than the above, the radiator may be formed of an industrial material such as aluminum nitride (AlN) or silicon carbide (SiC), or may be formed of a synthetic resin such as high thermal conductive resin. Although it is preferable that appearance configuration of the radiator approximates the shape of the neck portion of a general incandescent light having a shape that its diameter gradually becomes smaller from one edge portion to another edge portion because such a shape enables improvement in the application ratio of the radiator to existing lighting equipment, in the present application, approximating a general incandescent light is not a condition and appearance configuration is not limited to a specific one.

The lighting device includes a lighting circuit having, for example, a constant current DC power supply or the like.

Then, the configuration that a plurality of light emitting elements are derived from the center position of one main surface of the element substrate main body to be provided onto an outer edge side and simultaneously at least a part of the connection receiving part, to which the connection part connected to a distal end of the power feeder from the lighting device can be connected, and the wiring part including the wiring hole which is adjacent to the connection receiving part and penetrating the element substrate main body and allows insertion of the power feeder of the lighting device, is positioned at a spot that overlaps the center position of the one surface side of the element substrate main body enables to insert the power feeding part into the wiring hole for easy connection between the connection part and the connection receiving part. Therefore, it becomes possible to keep the connection receiving part away from each of the light emitting elements approximately the same distance so that emitted light is not easily blocked and a decrease in uniformity of light distribution is suppressed while ease in assembly is ensured.

Moreover, in the present invention, the radiator includes an insertion hole where the power feeding part of the lighting device can be inserted at a position that corresponds to the wiring hole of the element substrate in a condition where the element substrate main body of the element substrate is attached to one edge side of the radiator.

The insertion hole part is formed to have a circular shape having a diameter approximately the same as that of, for example, the wiring hole.

Then, providing the insertion hole part at a position that corresponds to the wiring hole of the element substrate in a condition where the element substrate main body of the element substrate is attached on the one edge side of the radiator enables to insert the power feeder from the lighting device into the radiator via the insertion hole part and simultaneously enables to increase the contact area between the element substrate main body and the one edge side of the radiator.

Moreover, the present invention includes a storage case which insulates the radiator and the cap, is provided between the radiator and the cap, and stores the lighting device.

Although it is preferable that the storage case is made of a synthetic resin having electric insulation properties and heat resistance, for example, polybutylene terephthalate (PBT), the storage case may be made of other synthetic resin such as acrylic or ABS. It is preferable that the storage case has a bottom of a cylindrical shape, but for reduction in material cost or improvement in heat radiation effect, to the extent that electrical insulation is not impaired the storage case may have a cylindrical shape or columnar shape with, for example, a lattice-shaped aperture.

Then, storing the lighting device in the storage case which is provided between the radiator and the cap and insulates the radiator and the cap easily insulates the lighting device with respect to the radiator and at the same time enables to easily provide the lighting device.

Further, the present invention includes the radiator including the one edge part having a support part where the element substrate is provided and another edge part having a storage concave portion where the lighting device is provided, the storage case having an aperture that communicates with the storage concave portion and which is arranged so as to intervene between the lighting device and the storage concave portion of the radiator, and includes a thermal conductive member which is provided to thermally connect the lighting device and surface of the storage concave portion of the radiator via the aperture of the storage case.

Although it is preferable that a substrate part of the lighting device is made of a metal excellent in thermal conductivity such as aluminum to increase the heat radiation property, the substrate part may be made of a non-metallic member such as glass epoxy, paper phenol, or glass composite, and further may be made of ceramics or the like. Although it is preferable that the lighting device is provided in the storage concave portion approximately along the center axis direction of the radiator to achieve reduction in size of the lighting device, even if the lighting device is provided in a direction orthogonal to the center axis, it is sufficient if the lighting device is inclined. Further, condition of the inside of the storage concave portion of the radiator where the lighting device is stored may be airtight or may be communicated with the outside by an air vent or the like for radiation or depressuring.

The lighting device may configure, for example, alighting circuit which converts 100V of AC voltage into 24V of DC voltage and supplies the converted voltage to the lighting element. Moreover, the lighting device may include a modulation circuit for modulating a semi-conductor light emitting element.

It is preferable that the thermal conductive member is made of a synthetic resin adhesive such as heat-resistant silicon resin, epoxy resin, or urethane resin having good thermal conductivity and electric insulation properties and is filled in the storage concave portion between the lighting device and the radiator via the aperture of the storage case to thermally connect the lighting device and the radiator. However, material of the adhesive is not limited only to these synthetic resins and a metal having good thermal conductivity such as aluminum or copper may be intervened between the lighting device and the radiator for connection or a combination of such a metal and a synthetic resin adhesive may be used for connection.

Moreover, for the thermal connection between the lighting device and the surface of the storage concave portion by the thermal conductive member, an aperture which communicates with the storage case is formed so as not to allow a thermal insulating member to intervene between the lighting device and the surface of the storage concave portion. However, as long as heat radiation performance can be ensured, the aperture does not need to penetrate and a thin film may be left to allow connection via the thin film. To summarize, the aperture may be configured to have a better thermal conductivity than other portions of the storage case.

Further, thermal connection between the lighting device and the surface of the storage concave portion may be carried out by forming a protrusion on the surface of the storage concave portion, forming a protrusion on the lighting device, or forming protrusions on both the lighting device and the surface of the storage concave portion to approximate the distance between the lighting device and the storage concave portion for connection so that thermal conductivity can be further improved.

Then, an aperture communicating with the storage concave portion may be formed on a part of the storage case intervening between the lighting device and the storage concave portion of the radiator and the lighting device and the surface of the storage concave portion of the radiator may be thermally connected with a thermal conductive member via this aperture. Thus, it becomes possible to provide a lamp which can efficiently radiate the heat generated by the lighting device and increase reliability.

Further, in the present invention, the lighting device is provided in the storage case approximately along the center axis direction of the radiator and the storage concave portion has a protrusion protruding toward the lighting device in an integrated manner, and the thermal conductive member connects the lighting device and the protrusion via an aperture.

In the present invention, although the lighting device is provided in the storage case approximately along the center axis direction of the radiator, the lighting device does not need to be provided exactly parallel to the center axis. For example, the lighting device may be provided while being inclined toward the center axis. To summarize, it is sufficient if the lighting device is provided approximately along the center axis direction in a manner that a large plate surface of the substrate part of the lighting device faces the protrusion of the storage concave portion.

Further, the protrusion protruding toward the lighting device may have a concave portion or a convex portion and a concave portion formed on a surface of the protrusion to increase the contact area with the thermal conductive member more.

Then, since the lighting device is provided in the storage case approximately along the center axis direction of the radiator, it becomes possible to configure a small lamp and at the same time to provide a lamp which allows the lighting device to be provided in a longitudinal direction so that a large area can face the storage concave portion of the radiator to increase the area connected to the thermal conductive member and heat generated by the lighting device can be more efficiently radiated to increase reliability.

Further, since the storage concave portion is formed with the protrusion protruding toward the lighting device in an integrated manner, it becomes possible to approximate the distance between the lighting device and the storage concave portion and at the same time to reduce the amount of adhesive to be used. Therefore, there is an advantage in cost.

Further, the present invention includes an equipment main body having a socket; and an LED lamp with a cap which is mounted on the socket of the equipment main body.

In the present invention, the lighting equipment may include a lamp directly installed on the ceiling, a lamp suspended from the ceiling, a lamp installed on the wall surface, or a downlight recessed in the ceiling. The lamp may be one to which a globe, a shade, or a reflector as a light control piece can be attached or one in which the lamp itself is exposed. Moreover, the lighting equipment is not limited to the equipment main body to which only one lamp is attached but a plurality of lamps may be attached. Further, large lighting equipment for facilities such as an office or for professional use may be configured.

Then, by the lamp installed in the equipment main body, it becomes possible to configure lighting equipment which can suppress a decrease in light distribution uniformity while ensuring ease in assembly and can increase reliability.

### BRIEF DESCRIPTION OF THE DRAWINGS

FIG. 1 is a longitudinal-sectional view of a lamp showing an embodiment of the present invention,

FIG. 2 is a plan view of an element substrate of the lamp,

FIG. 3 is a side elevational view of the lamp,

FIG. 4 is an explanatory view schematically showing a condition where lighting equipment on which the lamp is mounted is installed on a ceiling surface,

FIG. 5 is a longitudinal-sectional view of a lamp of a second embodiment of the present invention,

FIGS. 6(a) and (b) show a lamp of a further embodiment of the present invention where FIG. 6(a) is a longitudinal-sectional view and FIG. 6(b) is a perspective view of a storage case,

FIG. 7 is a perspective view showing a section of the lamp,

FIG. 8 is a graph showing the temperature of the lighting device of the lamp and the temperature of a conventional lighting device, and

FIGS. 9(a) through 9(d) shows modifications of the lamp, where FIG. 9(a) shows a longitudinal-sectional view of a first modification in which apart thereof is omitted, FIG. 9(b) shows a longitudinal-sectional view of a second modification in which a part thereof is omitted, FIG. 9c) shows a perspective view of a protrusion in a third modification, and FIG. 9(d) shows a perspective view of a protrusion in a fourth modification.

### DETAILED DESCRIPTION OF THE PREFERRED EMBODIMENTS

Hereinafter, embodiments of the present invention will be described with reference to the drawings.

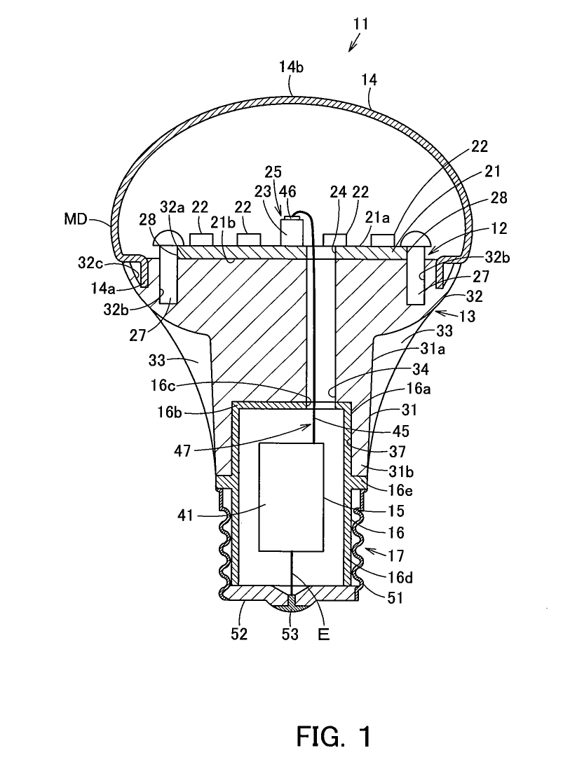

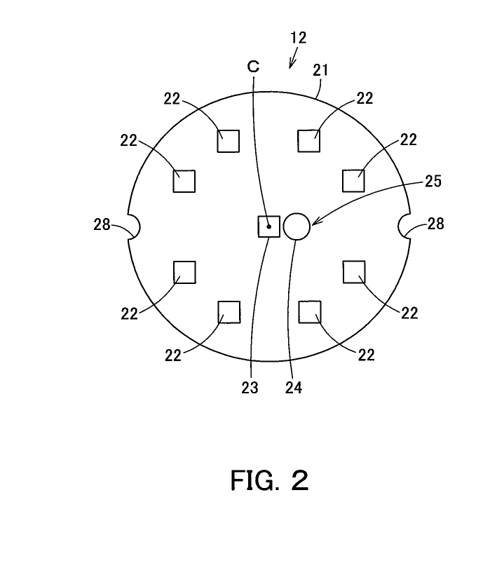

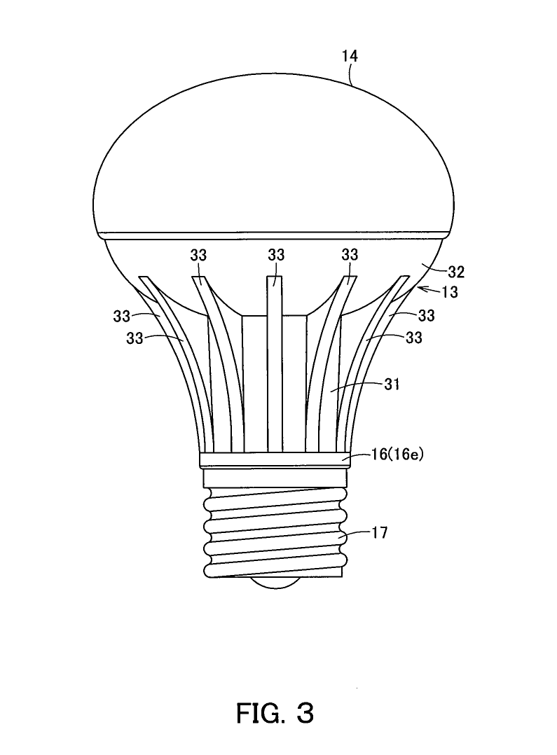

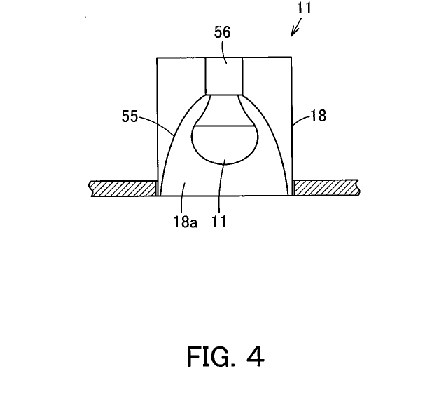

FIGS. 1 to 4 show an embodiment and FIG. 1 is a longitudinal-sectional view of a lamp, FIG. 2 is a plan view of an element substrate of the lamp, FIG. 3 is a side elevational view of the lamp, and FIG. 4 is an explanatory view schematically showing a condition where lighting equipment on which the lamp is mounted is installed on a ceiling surface.

In FIGS. 1 and 3, 11 is a self-ballasted LED lamp being a self-ballasted lamp as the lamp. The self-ballasted LED lamp 11 includes an LED substrate 12 which is an element substrate and is attached on one edge side of a radiator 13, a globe 14 which covers the LED substrate and is attached on the one edge side of the radiator 13, and a storage case 16 being an insulation case and storing a lighting circuit substrate 15 which is a lighting device, and a cap 17 is attached to the storage case 16. Moreover, the self-ballasted LED lamp 11 has the same length as a mini krypton lamp. Then, the self-ballasted LED lamp 11 is attached to an equipment main body 18 to be recessed for installation in a ceiling surface X of, for example, a shop, in a detachable manner to configure a downlight 19 which is lighting equipment.

As shown in FIGS. 1 and 3, the LED substrate 12 includes an LED substrate main body 21 which is a circular element substrate main body when seen planarly, a plurality of, for example eight, LEDs 22 which are semi-conductor light emitting elements as light emitting elements mounted on one main surface 21a side of the LED substrate main body 21, a connector receiving part 23 as a connection receiving part mounted on another main surface 21b side of the LED substrate main body 21, and a wiring part 25 having a round-shaped wiring hole 24 penetrating the LED substrate main body 21.

The LED substrate main body 21 is a metal substrate formed by a metallic material such as aluminum having good heat radiation properties, or an insulation material as shown in FIGS. 1 and 2. On both sides of the LED substrate main body 21, screwing portions 28 for closely fixing the substrate main body by screws 27 which are thermal connection units as fixing units are formed by threading so that the main body comes into surface contact with the radiator 13. Moreover, on the one main surface 21a of the LED substrate main body 21, a wiring pattern including a conductive member such as a copper foil is formed via an electric insulation layer such as silicon resin (not shown). Further, on the other main surface 21b of the LED substrate main body 21, an electric insulation layer (not shown) is formed. The electric insulation layer may be formed by attaching an insulation sheet depending on the necessity. Here, the LED substrate main body 21 may be bonded to the radiator 13 by, for example, a silicon series adhesive having good heat radiation properties.

The LEDs 22 have approximately the same capability, high-intensity and high power output and includes, for example, a bare chip emitting blue light (not shown) and a resin part including a silicon resin or the like covering the bare chip (not shown). Inside the resin part, a fluorescent body, which mainly radiates yellow color which is a complementary color of blue when excited by part of the blue light emitted by the bare chip, is mixed in (not shown) so that each of the LEDs 22 can obtain white color series illuminated light. The fluorescent body has, for example, about 0.5 W of power consumption. Moreover, these LEDs 22 are mounted on the wiring pattern on the one main surface 21a of the LED substrate main body 21 and are electrically connected in series to be provided on an outer edge portion of the one main surface 21a of the LED substrate main body 21 in a condition where the LEDs 22 are separated with an approximately same space on one same circle with the center position C of the LED substrate main body 21 as the center of the circle. Then, the LEDs 22 irradiate light in the approximately vertical direction toward the one main surface 21a of the LED substrate main body 21.

The connector receiving part 23 is a connector wafer (connector base) which is electrically connected to each of the LEDs 22 and becomes a terminal to be connected to the lighting circuit substrate 15 side. The connector receiving part 23 is formed of, for example, synthetic resin or the like, and is provided with its center matched to the center position C of the one main surface 21a of the LED substrate main body 21. Moreover, the connector receiving part 23 is provided longitudinally with an open upper portion.

The wiring hole 24 is provided adjacent to the connector receiving part 23 and has a diameter which is, for example, larger than the maximum dimension of the connector receiving part 23. Therefore, the wiring hole 24 is provided at a position that is in the vicinity of the center position C of the LED substrate main body 21 and is off from the center position C (offset) by the dimension a in the diameter direction (in the direction of outer circumference of the LED substrate main body 21).

Further, as shown in FIGS. 1 and 3, the radiator 13 includes an approximately cylindrical radiator main body 31, an enlarged diameter part 32 expanding to one edge 31a side of the radiator main body 31 in an enlarged diameter state, and a plurality of heat radiating fins 33 expanding along the outer circumference surface of the radiator main body 31 and the enlarged diameter part 32. The radiator main body 31, the enlarged diameter part 32, and the heat radiating fins 33 are made of a metallic material such as aluminum or a resin material excellent in thermal conductivity and are formed in an integrated manner by casting, forging, or cutting processing to be a member having a thick inner wall without a hollow inside. Further, the radiator 13 is formed to have an external appearance that approximates the shape of the neck part of a general incandescent bulb as the cross section of the radiator 13 becomes an approximately round shape and an outer circumference surface having an approximate conical taper surface that gradually becomes smaller from one edge to another edge. Then, an insertion hole part 34 is formed penetrating via the radiator main body 31 and the enlarged diameter part 32.

To the radiator main body 31, a mating concave portion 37 as a storage concave portion for inserting one edge 16a side of the storage case 16 is provided on another edge 31b side along the center axis. The mating concave portion 37 has a cross-section which is approximately round shaped with the center axis y-y of the radiator 13 as its center and communicates with the insertion hole part 34.

The enlarged diameter part 32 is enlarged in diameter into a flat spherical shape from the radiator main body 31 side and an upper edge side thereof is a flat substrate attachment surface 32a as a support part where the LED substrate main body 21 of the LED substrate 12 is placed. Then, there are the upper edge part of the insertion hole 34 on the substrate attachment surface 32a and a screwing hole 32b for screwing the screw 27 corresponding to the screwing portion 28 of the LED substrate 12. That is, the insertion hole 34 is formed at a position which is a little off (offset) in the diameter direction to the center position of the substrate attachment surface 32a. Moreover, in the vicinity of an outer edge portion of the substrate attachment surface 32a of the enlarged diameter part 32, a concave groove portion 32c where an edge portion of one edge 14a side of the globe 14 is fitted and locked is formed continuously along the circumferential direction in a circular shape.

The heat radiating fins 33 are formed being inclined so that protrusion in the diameter direction from the radiator main body 31 to the enlarged diameter part 32 side gradually increases. Moreover, the heat radiating fins 33 are formed with an approximately same space between each other in the circumferential direction of the radiator 13.

The insertion hole 34 is formed to have around hole having an approximately same diameter as the wiring hole 24.

The globe 14 is formed of transparent or translucent white glass or synthetic resin having light diffuseness to have a flat spherical shape which expands to the upper edge side of the enlarged diameter part 32 of the radiator 13. That is, the globe 14 is formed in a smooth curved surface shape approximating the shape of the ball portion of a general incandescent bulb. Moreover, the globe 14 is formed to be enlarged and opened from the one edge 14a side and the diameter of the globe 14 gradually becomes smaller from the maximum diameter position MD to the other edge 14b side. The maximum diameter position MD is in a higher position than each of the LEDs 22 of the LED substrate 12. Further, the globe 14 covers the light emitting surface of the LED substrate 12 and the one edge 14a side of the globe 14 is fixed to the circumference edge of the enlarged diameter part 32 of the radiator 13 by, for example, an adhesive such as silicon resin or epoxy resin. As a result, the LED substrate 12 is covered with the globe 14 to be protected and at the same time the outer circumference surface shape of the radiator 13 is approximately continued to the outer circumference surface shape of the globe 14 in an integrated manner when seen from the outside. Therefore, the self-ballasted LED lamp 11 can approximate the shape of a general incandescent bulb as a whole.

The lighting circuit substrate 15 includes a lighting circuit substrate main body 41 which is a lighting device main body formed in a flat board shape by, for example, glass epoxy material or the like, circuit elements which are a plurality of electric parts mounted on the lighting circuit substrate main body 41 to configure the lighting circuit (not shown), and a power feeding part 47 including a power feeder 45 having a proximal end electrically connected to the lighting circuit and a connection part 46 electrically connected to a distal end of the power feeder 45, and is stored in the storage case 16 along the axis direction. Moreover, an input wire (not shown) is connected to an input terminal of the lighting circuit substrate 15.

The lighting circuit is a circuit for supplying a constant current to, for example, the LEDs 22 and is configured to supply the current to each of the LEDs 22 after 100V of an alternative current voltage is converted into 24V of a direct current voltage.

The power feeder 45 is for supplying power from the lighting circuit side to the LED substrate 12 side and has a length that is longer than the distance from the lighting circuit to the LED substrate 12. Here, the extra length of the power feeder 45 can be stored in the insertion hole 34.

The connection part 46 is a connector housing to be a power supply terminal to which the distal end portion side of the power feeder 45 is connected and is inserted and fixed to a direction orthogonal (vertical) to the LED substrate main body 21 from the upper side to the lower side of the connector receiving part 23 on the LED substrate 12 side so that the power feeder 45 (lighting circuit) can be electrically connected to the LEDs 22 side via the connector receiving part 23. Moreover, the connector part 46 is designed to have a maximum dimension that is smaller than the diameter of the wiring hole 24 or the diameter of the insertion hole 34. Therefore, the power feeder 45 and the connection part 46 (power feeding part 47) can be inserted into the wiring hole 24 and the insertion hole 34. Here, the connection part 46 is an independent member in the present embodiment. However, in a case where the connection receiving part is a terminal block or the like, the connection part 46 may be the distal end of the power feeder 45 itself.

The storage case 16 is for electric insulation between the lighting circuit substrate 15 and the radiator 13 and is made of a material such as PBT resin having insulation properties to be formed in an approximately cylindrical shape along the shape of the inside of the mating concave portion 37. Moreover, one edge 16a side of the storage case 16 is closed by a closing plate 16b which is a case closing part and on the closing plate 16b, a communication hole 16c which has an approximately same diameter as the insertion hole 34 and is communicated with the insertion hole 34 is opened. Further, on an outer circumference surface of a medium part between the one edge 16a side and the other edge 16d side of the storage case 16, a flange portion 16e for insulating between the other edge 31b of the radiator main body 31 of the radiator 13 and the cap 17 is continuously formed in the whole in the circumferential direction in a protruding manner toward the diameter direction. Here, inside the storage case 16, silicon series resin or the like which is a filler having heat radiation and insulation properties may be filled so that the lighting circuit substrate 15 is embedded.

The cap 17 is, for example, an Edison type E17 model and is electrically connected to the lighting circuit substrate 15 side by a wiring (not shown). The cap 17 includes a tubular shell 51 having a screw thread to be screwed into a lamp socket of lighting equipment (not shown) and an eyelet 53 provided on the top of one edge side of the shell 51 via an insulation part 52 and is fixed to the storage case 16 by bonding, swage, or the like.

The shell 51 is electrically connected to a power source side (not shown) and inside the shell 51, a power source wire for feeding power to the lighting circuit of the lighting circuit substrate 15 (not shown) is sandwiched for conduction to the shell 51.

The eyelet 53 is electrically connected to ground potential (not shown) and the eyelet 53 is electrically connected to ground wire E by soldering or the like which is electrically connected to the ground potential of the lighting circuit of the lighting circuit substrate 15.

Moreover, the equipment main body 18 is for existing downlight type lighting equipment having, for example, a general incandescent bulb as a light source which includes an E17 model cap and is formed to have a metallic box shape having an aperture 18a on a lower surface thereof. A metallic reflector 55 is fitted with the aperture 18a and at the same time a socket 56 to which the cap 17 can be screwed in is provided.

The reflector 55 is formed of, for example, a metal plate such as stainless steel, and the socket 56 is provided in the center portion of an upper surface plate.

Then, the downlight 19 is an existing one for a general incandescent bulb and for energy saving and long life of the light, the self-ballasted LED lamp 11 is used instead of the incandescent bulb. That is, because the cap 17 of the self-ballasted LED lamp 11 is configured to have the shape of the E17 model, the LED lamp 11 can be screwed in the socket 56 without changes or modification. At this time, because the radiator 13 forms an approximately conical taper surface having a shape approximating the shape of the neck portion of the incandescent bulb, the neck portion does not come into contact with the reflector 23 in the periphery of the socket 56 to enable smooth screwing into the socket. Therefore, application ratio of the self-ballasted LED lamp 11 to the existing equipment main body 18 is improved and the energy-saving type downlight 19 in which the self-ballasted LED lamp 11 is installed is configured.

Next, operation of the above-mentioned embodiment will be described.

When the self-ballasted LED lamp 11 is assembled, the other main surface 21b side of the LED substrate main body 21 of the LED substrate 12 on which the LEDs 22, the connector receiving part 23, and the like are mounted is placed first on the substrate attachment surface 32a of the radiator 13, the positions of the wiring hole 24 and the insertion hole 34 are matched, and while the positions of the screwing portions 28 on the LED substrate main body 21 side and the screwing holes 32b on the radiator 13 side are matched, the LED substrate 12 is fixed to the radiator 13 by the screws 27 so that the LED substrate 12 and the radiator 13 are thermally connected.

Moreover, the proximal end of the power feeder 45 having the connection part 46 on the distal end side is electrically connected to the output terminal of the lighting circuit of the lighting circuit substrate 15.

Next, the storage case 16 in which the lighting circuit substrate 15 is stored is inserted into the mating concave portion 37 of the radiator 13 so that the communication hole 16c communicates with the insertion hole part 34 and the storage case 16 is locked and fixed to the radiator 13 by a convexo-concave structure (not shown) or the like. At this time, the power feeding part 47 is inserted into the insertion hole part 34, the distal end of the power feeder 45 and the connection part 46 are projected from the one main surface 21a of the LED substrate main body 21 of the LED substrate 12, and the connection part is inserted from above into the connector receiving part 23 so that the connector receiving part 23 and the connection part 46 are electrically and mechanically connected.

Subsequently, the cap 17 to which the eyelet 53 is connected via the lighting circuit substrate 15 and the earth cable E is inserted from the other edge 16d side of the storage case in a condition where the power wire electrically connected to the lighting circuit substrate 15 side is led to the outside of the shell 51 to sandwich the power wire between the storage case 16 and the shell 51. At this time, the storage case 16 and the cap 17 are locked and fixed by a convexo-concave structure (not shown) or the like.

Then, the one end 14a side of the globe 14 is fit into the concave groove part 32c of the radiator 13 to fix the globe to the radiator 13 and the fixed portion is reinforced by an adhesive or the like to complete the self-ballasted LED lamp 11.

After the self-ballasted LED lamp 11 is mounted on the socket 56 and power is supplied to the downlight 19, power is supplied to the self-ballasted LED lamp 11 from the socket 56 via the cap 17 and the lighting circuit of the lighting circuit substrate 15 is operated to output 24V of a direct current voltage. By this direct current voltage, power is supplied to the LED substrate 12 side via the power feeder 45 connected to the output terminal of the lighting circuit. Thus, all the LEDs 22 emit light simultaneously to radiate white color light.

At this time, since each of the LEDs 22 is mounted on the one surface 21a of the LED substrate main body 21 to form an approximately circular shape with a substantially equal interval, the light emitted from each of the LEDs 22 is not blocked by the connector receiving part 23 or the like and is irradiated to the whole of the inner surface of the globe 14 substantially equally and the light is diffused by the translucent white globe 14 to enable lighting having light distribution characteristics similar to those of a general incandescent bulb.

In particular, as light distribution of the self-ballasted LED lamp 11 which is a light source becomes closer to the light distribution of the general incandescent bulb, irradiance level of light to the reflector 55 in the vicinity of the socket 56 provided in the downlight 19 is increased and it becomes possible to substantially obtain the optically designed equipment characteristics of the reflector 55 configured for the general incandescent bulb.

Moreover, heat generated from each of the LEDs 22 on the LED substrate 12 when the LED lamp 11 is turned on is transmitted to the radiator 13 via the substrate attachment surface 32a and is radiated from each of the heat-radiation fins 33, radiator main body 31, and the enlarged diameter part 32. Further, heat remaining in the storage case 16 is transmitted to the cap 17 and is radiated.

As mentioned above, a plurality of LEDs 22 are provided at positions deviating to the outer edge side from the center position C of the one main surface 21a of the LED substrate main body 21 and the wiring part 25 including the connector receiving part 23, which can be connected to the connection part 46 connected to the distal end of the power feeder 45 from the lighting circuit substrate 15, and the wiring hole 24 which is provided adjacent to the connector receiving part 23 and is penetrating the LED substrate main body 21 so that the power feeding part 47 of the lighting circuit substrate 15 can be inserted in, is provided at a position that overlaps the center position C of the one main surface 21a side of the LED substrate main body 21 to allow the power feeding part 47 to be inserted into the wiring hole 24 and to allow easy connection between the connection part 46 and the connector receiving part 23. Therefore, it becomes possible to keep the connector receiving part 23 away from each of the LEDs 22 with substantially equal distance so that emitted light is hardly blocked and to suppress a decrease in uniformity of light distribution while ensuring ease in assembly.

Moreover, since the connector receiving part 23 is longitudinally provided on the one main surface 21a of the LED substrate main body 21 of the LED substrate 12, the connection part 46 of the power feeding part 47 inserted into the insertion hole part 34 and the wiring hole 24 can be easily connected to the connector receiving part 23. At the same time, a load is not easily applied to the vicinity of the connection position between the power feeder 45 and the connection part 46 in a condition where the connector receiving part 23 is connected to the connection part 46 and the power feeder 45 is not easily damaged in a case where the connection part 46 is connected to the connector receiving part 23 or the like.

Further, providing the insertion hole part 34 at a position which corresponds to the wiring hole 24 of the LED substrate 12 in a condition where the LED substrate main body 21 of the LED substrate 12 is attached to the substrate attachment surface 32a on one edge side of the radiator 13 enables the power feeder 45 from the lighting circuit substrate 15 to be inserted into the radiator 13 via the insertion hole part 34 and at the same time to maximize the contact area between the LED substrate main body 21 and the substrate attachment surface 32a on the one edge side of the radiator 13.

Then, storing the lighting circuit substrate 15 in the storage case 16, which is provided between the radiator 13 and the cap 17 and insulates the radiator 13 and the cap 17, enables to easily insulate the lighting circuit substrate 15 to the radiator 13 and at the same time to easily provide the lighting circuit substrate 15.

Moreover, the LED substrate 12 (LEDs 22) is provided at a position lower than the maximum diameter position MD of the globe 14 to enable part of the light emitted from each of the LEDs 22 to be irradiated on the lower side by the curved shape from the one edge 14a side of the globe 14 to the maximum diameter position MD. Therefore, it becomes possible to irradiate the light in a wider range.

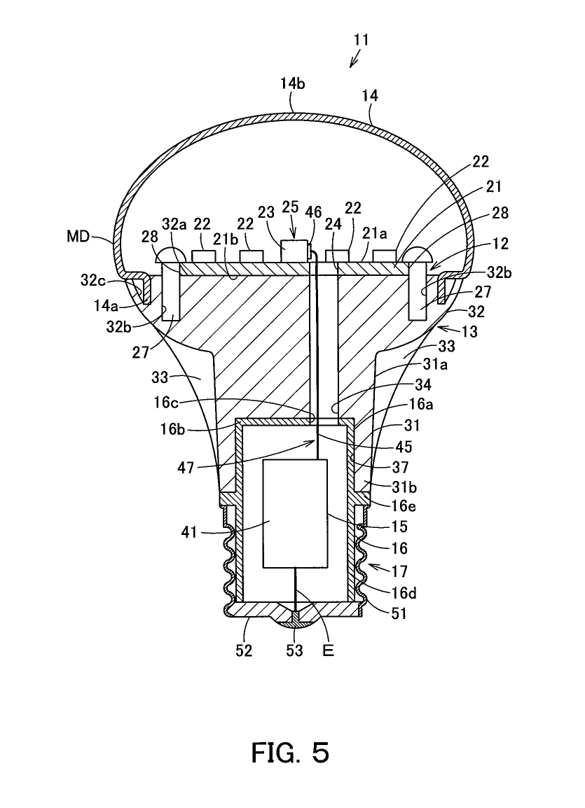

Next, another embodiment is shown in FIG. 5. FIG. 5 is a longitudinal-sectional view of a lamp. Here, the same reference numerals are given for those components having the same configurations and operation as in the above embodiment and explanation thereof is omitted.

This embodiment is one in which the connector receiving part 23 is provided horizontally in the above-mentioned embodiment.

That is, the connector receiving part 23 is open toward the direction along the one main surface 21a (horizontal direction) on the wiring hole 24 side on the one main surface 21a of the LED substrate main body 21 of the LED substrate 12 and the connection part 46 can be inserted and fixed in the connector receiving part 23 along the LED substrate main body 21.

The connector receiving part 23 is thus provided horizontally to enable reduction in the degree of protrusion of the connector receiving part 23 from the LED substrate main body 21. Therefore, light from the LEDs 22 is not easily blocked by the connector receiving part 23 and a decrease in uniformity of light distribution can be suppressed more.

Here, in each of the above-mentioned embodiments, the connector receiving part 23 and the wiring hole 24 can be provided arbitrarily as long as the connector receiving part 23 and the wiring hole 24 are provided adjacent to each other and the wiring part 25 is provided in a manner that at least part thereof overlaps the center position of the LED substrate main body 21 of the LED substrate 12. That is, it becomes possible to obtain a similar effect even if the connector receiving part 23 and the wiring hole 24 are provided in a condition where part of either of them is provided overlapping the center position C of the LED substrate main body 21, a condition where part of an area between the connector receiving part 23 and the wiring hole 24 is in the vicinity of the position that overlaps the center position C of the LED substrate main body 21, or the like.

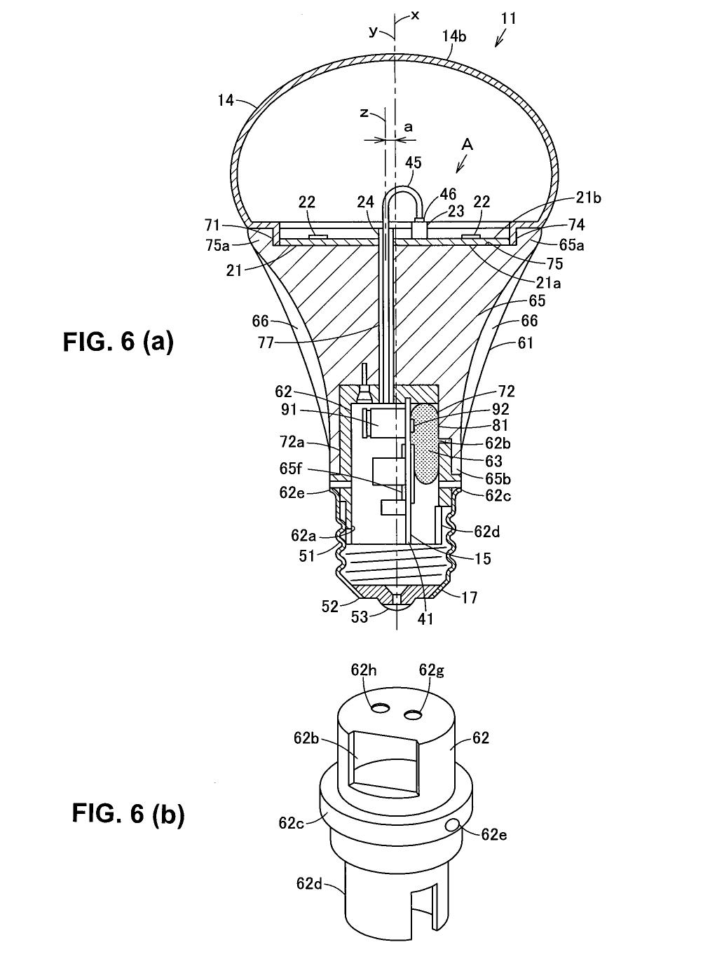

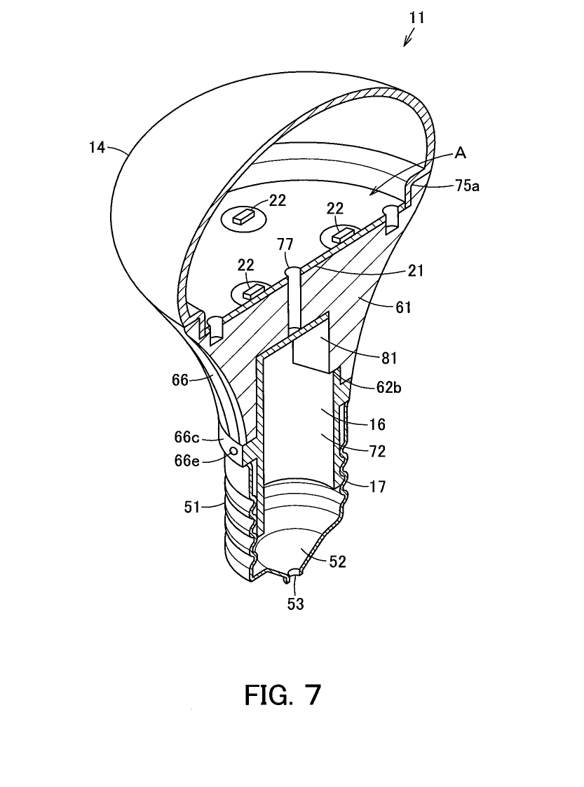

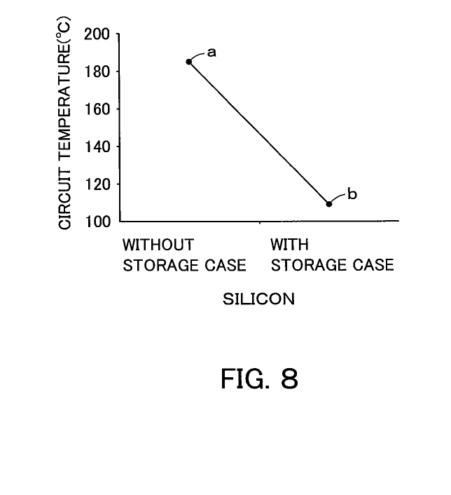

Next, a further embodiment is shown in FIGS. 6 to 8. FIG. 6 shows a lamp, where (a) is a longitudinal-sectional view and (b) is a perspective view of a storage case, FIG. 7 is a perspective view showing a section of the lamp and FIG. 8 is a graph showing the temperature of the lighting device of the lamp and the temperature of a conventional lighting device. Here, the same reference numerals are given for those components having the same configurations and operation as in each of the above-mentioned embodiments and explanation thereof is omitted.

In this embodiment, instead of the radiator 13 and the storage case 16 in the above embodiment, a radiator 61 being a main body and a storage case 62 being an insulation case are used and the lighting circuit substrate 15 and the radiator 61 are thermally connected by a thermal conductive member 63.

The radiator 61 includes a metal excellent in thermal conductivity, for example, aluminum, and is formed to have an external appearance that approximates the shape of the neck part of a general incandescent bulb as the cross section of the radiator 61 becomes an approximately round shape and an outer circumference surface is approximately a conical taper surface that gradually becomes smaller in diameter from one edge to other edge. Moreover, the radiator 61 includes an approximately columnar radiator main body 65 and a plurality of heat-radiating fins 66 formed in an integrated manner on an outer circumference surface of the radiator main body 65. Then, the radiator 61 is processed by casting, forging, or cutting processing to be a member having a thick inner wall without a hollow inside.

An aperture 71 having a large diameter is formed on one edge 65a of the radiator main body 65 and at the same time a mating concave portion 72 as a storage concave portion having a small aperture 72a is formed on another edge 65b.

To the aperture 71, a support part 75 having a smooth surface so that a concave portion 74, to which the LED substrate 12 is to be attached, can be formed is formed in an integrated manner. That is, the LED substrate 12 is supported by the radiator main body 65 by a fixing unit such as a screw in a condition where the other main surface 21b side of the LED substrate main body 21 is in close contact with the support part 75 via an insulation sheet or an adhesive including silicon resin or the like having both thermal insulation properties and electric insulation properties. Thus, a light axis x-x of the LED substrate 12 approximately matches the center axis y-y of the radiator 61 and a light source part A having a substantially circular light emitting surface when viewed planarly is configured as a whole.

Moreover, an insertion hole 77 where the power feeder 45 can be inserted is formed on the radiator main body 65. The insertion hole 77 is formed penetrating from the center portion of the support part 75 to the aperture 72a approximately along the direction of the center axis y-y. Moreover, the center axis z-z of the insertion hole 77 is formed at a position that is deviated in the outer circumference direction from the center axis y-y of the radiator 61 by dimension a so as to communicate with the wiring hole 24 of the LED substrate main body 21.

The mating concave portion 72 is a concave portion for providing the lighting circuit substrate 15 inside, has a cross-section that forms an approximately round shape with the center axis y-y of the radiator 61 as its center, and the insertion hole 77 is formed on the bottom surface. Moreover, on the surface of the mating concave portion 72, a protrusion 81 is formed integrally on a part of the circumference from the bottom surface to an approximately medium part of the inner surface so that the shape of the cross-section surface does not become round shaped but has a thick wall.

Further, the heat-radiating fins 66 are formed on the outer circumference surface of the radiator main body 65 in a manner that the fin protrudes from one end 65a to the other end 65b.

Further, the storage case 62 is formed to have a cylindrical shape having a bottom which approximately matches the inner surface shape of the mating concave portion 72 of the radiator 61 and an aperture 62a is formed on a one end portion while the other end portion is closed.

Further, on an inner surface side of the storage case 62, an aperture 62b, which forms a rectangular shape from the bottom surface to an approximate medium portion of the inner surface on a part of the circumference, is partially formed. The aperture 62b is formed so as to communicate with the mating concave portion 72 of the radiator 61 and is formed to have the shape and size that allows the protrusion 81 of the mating concave portion 72 to be fitted, so that the protrusion 81 is automatically fitted in the aperture 62b and the protrusion 81 is protruded and exposed on the inner surface of the storage case 62 when the storage case 62 is inserted into the mating concave portion 72 with its bottom surface first.

Further, on an approximate medium portion of the outer circumference of the storage case 62, a locking part 62c protruding like a ring-shaped guard is formed integrally and a cap attachment portion 62d with its outer circumference caused to have a terraced shape is formed integrally in a portion which protrudes from the locking part 62c while an air vent hole 62e for communicating with external air when the pressure inside the storage case 62 is increased is formed on a lower surface of the part where the guard shape of the locking part 62c is formed.

Further, on the inner surface of the storage case 62, a guide groove 62f is formed integrally along the axis direction of the cylinder and the lighting circuit main body 41 of the plate-shaped lighting circuit substrate 15 is fitted and supported by the guide groove 62f along the longitudinal direction, that is, approximately along the center axis y-y of the radiator 61. The guide groove 62f is formed on the side of the axis line of the cylindrical storage case 62, in other words, formed disproportionately on one side from the center axis y-y of the radiator 61, according to the present embodiment, on the side where the aperture 62b and the protrusion 81 are formed (deviated) and the lighting circuit substrate main body 41 is fitted to the disproportionately formed guide groove 62f in the longitudinal direction. Thus, a large plate surface of the lighting circuit substrate main body 41 is positioned toward the protrusion 81 from the aperture 62b and at the same time is supported at a position which is in the vicinity of the protrusion 81.

Further, the LED substrate 12 includes four LEDs 22 which are mounted on the one main surface 21a of the LED substrate main body 21 according to the present embodiment.

Further, regarding the lighting circuit substrate 15, relatively large parts 91 such as an electrolytic capacitor are intensively provided on one surface of the lighting circuit substrate main body 41 and parts 92 which are relatively small parts such as chips or transistors and generate heat are mounted on the other surface. When the lighting circuit substrate main body 41 of the lighting circuit substrate 15 is inserted and fitted in the guide groove 62f of the storage case 62 in the longitudinal direction, parts 92 which relatively generate more heat by chips or transistors are positioned in a space on the side where the aperture 62b and the protrusion 81 are provided, while the large parts 91 are positioned in the other large space. Here, when a circuit element is mounted on the lighting circuit substrate main body 41, it is preferable that the parts 92 such as transistors which relatively generate heat are positioned in advance so that the parts 92 face the aperture 62b and the protrusion 81. In this case, if the lighting circuit substrate 15 is stored in the storage case 62, electric insulation between the radiator 61 and the lighting circuit substrate 15 occurs due to the storage case 62 and at the same time the parts 92 such as transistors which relatively generate heat are automatically caused to face the aperture 62b and the protrusion 81. In a condition where the heat-generating parts 92, the aperture 62b and the protrusion 81 are facing, a thermal conductive member, according to the present embodiment, a heat-resistant adhesive 94 made of silicon resin or the like having electric insulation properties is filled between the plate surface including the heat-generating part 92 of the lighting circuit substrate main body 41 and the protrusion 81 on the surface of the mating concave portion 72 exposed from the aperture 62b.

Thus, due to the adhesive 94 made of silicon resin, the lighting circuit substrate 15, especially the heat-generating parts 92, and the protrusion 81 of the radiator 61 are thermally connected while electric insulation is achieved between the radiator 61 and the lighting circuit substrate 15 made of aluminum and at the same time the lighting circuit substrate 15 is fixed more strongly to the storage case 62 and the radiator 61 by the adhesive 94.

Here, 62g in FIG. 6(b) is a communication hole formed on the bottom surface corresponding to the insertion hole 77 of the radiator 61 and the power feeder 45 is pulled out into the storage case 62. 62h is a screw hole for fixing the storage case 62 on the bottom surface of the mating concave portion 72.

The cap 17 is fitted in an outer circumference surface of a cap attachment part 62d of the storage case 62 which projects from the aperture 72a of the other end portion of the radiator 61, and the fitted portion is swaged or fixed by an adhesive made of silicon resin or epoxy resin which has heat-resistance properties. Thus, the external shape of the outer circumference from the radiator 61 to the cap 17 is configured to have a shape approximating the shape of a neck portion of a general incandescent bulb.

Moreover, for the cap 17, an Edison type E26 model, for example, is used. Therefore, it is assumed that each part of the lighting equipment 18 has a size and shape which correspond to the E26 model.

Next, assembly process of the above-mentioned embodiment will be explained.

The storage case 62 is fitted in the mating concave portion 72 of the radiator 61 first and is fixed to the bottom surface of the mating concave portion 72 by a screw using a screw hole 62g. At this time, while the aperture 62b of the storage case 62 is fitted to the protrusion 81 of the mating concave portion 72, the communication hole 62h is fitted to the insertion hole 77 of the radiator 61 for fixing.

Next, while the power feeder 45 connected to an output terminal of the lighting circuit substrate 15 in advance is caused to pass from the communication hole 62h to the insertion hole 77 of the radiator 61, the lighting circuit substrate 15 is turned lengthwise to be inserted in the storage case 62 and the lighting circuit substrate main body 41 is fitted to the guide groove 62f for supporting the lighting circuit substrate 15. At this time, the lighting circuit 15 is inserted in a manner that the heat-generation parts 92 face the aperture 62b and the protrusion 81. At this time, the distal end including the connection part 46 of the power feeder 45 is pulled out from the wiring hole 24 of the LED substrate main body 21 mounting the LEDs 22.

Next, in a condition where the lighting circuit substrate 15 is supported in the storage case 62, the adhesive 94 is injected to fill a space between the lighting circuit substrate 15 and the protrusion 81 in the storage case 62. Thus, the plate surface of the lighting circuit substrate main body 41 including the heat-generating parts 92 mounted on the lighting circuit substrate main body 41 of the lighting circuit substrate 15 and the protrusion 81 of the radiator 61 are connected by the adhesive 94.

Next, the LED substrate 12 is mounted on the support part 75 of the radiator 61 and is caused to be in close contact with the support part 75 to be fixed by fixing units such as screws at four spots or so from the one main surface 21a side of the LED substrate main body 21. At this time, positions of the wiring hole 24 of the LED substrate main body 21 and the insertion hole 77 of the radiator 61 are matched and fixed. Thus, the other main surface 21b of the LED substrate main body 21 and the smooth surface of the support part 75 are brought into close contact and fixed.

Next, the power feeder 45 with its one end pulled out from the wiring hole 24 of the LED substrate main body 21 is folded to the LED substrate main body 21 side so that the connection part 46 is mechanically and electrically connected to the connector receiving part 23.

Next, an input wire led out from the input terminal of the lighting circuit substrate 15 (not shown) is connected to the shell 51 and the eyelet 53 of the cap 17 and in the connected condition, the aperture of the shell 51 is fitted to the cap attachment part 62d of the storage case 62 to be fixed by an adhesive.

Next, the globe 14 is prepared and one end 14a side of the globe 14 is fitted in a terraced part 75a formed in the support part 75 of the radiator 61 to be fixed by an adhesive so as to cover the light source part A of the radiator 61.

Thus, one end part has the globe 14 and the cap 17 is provided to other end part to configure the self-ballasted LED lamp 11 having an external shape approximating a general incandescent bulb and brightness equivalent to the incandescent bulb of 40W by about 4W of a rated lamp wattage.

Then, after the self-ballasted LED lamp 11 is mounted on the socket 56, power is charged to the downlight 19 to supply power to the self-ballasted LED lamp 11 from the socket 56 via the cap 17 and the lighting circuit is driven to output 24V of a direct current voltage. The DC voltage is applied to each of the LEDs 22 connected in series via the power feeder 45 connected to the output terminal of the lighting circuit. Thus, all the LEDs 22 are lit simultaneously to emit white color light.

By the lighting of the self-ballasted LED lamp 11, the circuit element of the lighting circuit, especially the parts 92 such as a transistor, generates heat. The heat thus generated is transmitted to the protrusion 81 of the mating concave portion 72 via the adhesive 94 made of silicon resin which is a thermal conductive member and is radiated to ambient air from the thick radiator 61 made of aluminum via the heat-radiating fins 66. Simultaneously, heat of the lighting circuit substrate 15 is transmitted to the protrusion 81 via the adhesive 94 as the temperature of the substrate is raised by the heat of the parts. Further, heat remaining inside the storage case 62 is transmitted to the cap 17 and radiated and at the same time radiated outside from the air vent hole 62e formed on the locking part 62c of the storage case 62 by convection.

At this time, since the aperture 62b is provided to the storage case 62 and the lighting circuit substrate 15 and the protrusion 81 of the mating concave portion 72 are directly connected by the adhesive 94, it becomes possible to effectively radiate heat reducing conduction loss. For example, when the temperature of a lighting circuit substrate in a case where heat is radiated from the lighting circuit substrate to the storage case and from the storage case to ambient air via a cover member as in a conventional art was measured, temperature of the lighting circuit substrate was about 185° C. (point a in the graph) because heat resistance became high, as shown in the graph of FIG. 8. However, temperature of the lighting circuit substrate 15 according to the present embodiment was about 110° C. (point b in the graph) because heat resistance was smaller and therefore, the temperature was lowered by about 75° C.

Moreover, temperature of each of the LEDs 22 also rises simultaneously and heat is generated. The heat is transmitted from the disc-shaped LED substrate main body 21 made of aluminum to the support part 75 to which the LED substrate main body 21 is made in close contact and fixed and is radiated to ambient air from the radiator 61 made of aluminum via the heat-radiating fins 66. At this time, since the LED substrate main body 21 and the radiator 61 are made of aluminum excellent in thermal conductivity, the heat generated by each of the LEDs 22 can be effectively radiated while reducing conduction loss.

Thus, it becomes possible to prevent an increase and variation in temperature of each of the LEDs 22, to suppress a decrease in light emitting efficiency, to prevent a decrease in illumination intensity caused by lowered light flux, and to achieve long life of the LEDs 22. Moreover, the light can be light-weighted because of aluminum without making it heavy as a bulb.

According to the above-mentioned embodiment, the aperture 62b communicating with the mating concave portion 72 is partially formed on the storage case 62 for storing the lighting circuit substrate 15 and the lighting circuit substrate 15 and the mating concave portion 72 of the radiator 61 are thermally connected by the adhesive 94 made of silicon resin, which is a thermal conductive member, via the aperture 62b. Therefore, heat generated from the circuit element of the lighting circuit substrate 15 can be effectively radiated and a rise in temperature of the circuit element can be prevented. Thus, it becomes possible to provide the self-ballasted LED lamp 11 and the downlight 19 which have high reliability and can suppress a decrease in life time because a cause of a circuit trouble is eliminated.

In particular, since the lighting circuit substrate 15 is provided in the mating concave portion 72 approximately along the center axis y-y of the radiator 61, in the self-ballasted LED lamp 11 with its center axis in the longitudinal direction, it becomes possible to configure a portion equivalent to the neck portion of a general incandescent bulb thin and small and to configure the small self-ballasted LED lamp 11 approximating the shape of the self-ballasted bulb. At the same time, the lighting circuit substrate 15 enables the lighting circuit substrate main body 41 to be set vertically so that a large plate surface thereof faces the surface of the mating concave portion 72 of the radiator 61. Therefore, it becomes possible to increase an area of the thermal conductive member 63 which is thermally connected, to reduce conduction loss more, and to more effectively transmit the heat of the lighting circuit substrate 15 to the radiator 61 side.

Moreover, since the protrusion 81 which protrudes toward the lighting circuit substrate 15 is formed integrally on the surface of the mating concave portion 72, it becomes possible to shorten the distance between the lighting circuit substrate 15 and the mating concave portion 72, to transmit the heat of the lighting circuit substrate 15 to the radiator 61 side more effectively, and at the same time to reduce the amount of the adhesive 94 used made of expensive silicon resin or the like. Therefore, there is an advantage in cost. Further, the protrusion 81 of the mating concave portion 72 can be formed integrally when the radiator 61 is configured and therefore it becomes unnecessary to prepare an exclusive part and possible to simplify the assembly operation. Therefore, it becomes possible to provide the self-ballasted LED lamp 11 suitable for mass-production.

Further, since the lighting circuit substrate 15 is provided vertically in a derived manner on the side where the aperture 62b and the protrusion 81 are formed, the lighting circuit substrate 15 is supported at a position close to the protrusion 81. Therefore, it becomes possible to transmit the heat of the lighting circuit substrate 15 to the radiator 61 side with less conduction loss and at the same time to reduce the amount of the adhesive 94 used.

Further, since the adhesive 94 made of silicon resin is filled in a space between the plate surface of the lighting circuit substrate 15 and the protrusion 81 protruding from the aperture 62b to be exposed in a condition where the lighting circuit substrate 15, the aperture 62b and the protrusion 81 are facing, if the radiator 61 and the lighting circuit substrate 15 made of aluminum are electrically insulated by the adhesive 94, the lighting circuit substrate 15 and the protrusion 81 of the radiator 61 are thermally connected simultaneously and the lighting circuit substrate 15 is more strongly fixed to the storage case 62 and the radiator 61 by the adhesive 94. Therefore, it becomes possible to provide the self-ballasted LED lamp 11 which is electrically safe, has high reliability, and can withstand vibration or the like.

Here, in the above-mentioned embodiment, the adhesive 94 made of silicon resin or the like, which is a thermal conductive member, is filled only in a space between the plate surface of the lighting circuit substrate 15 and the protrusion 81. However, the adhesive 94 may be filled in all of this portion including the back surface side where the large parts 91 are mounted.

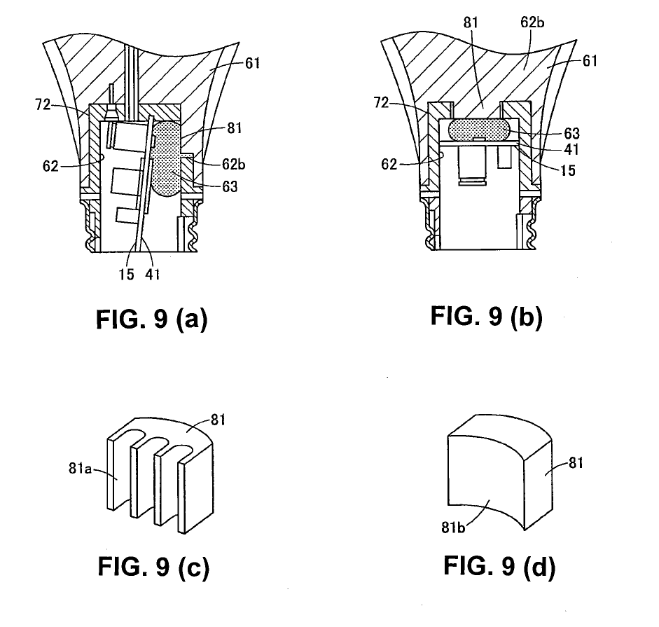

Further, although the lighting circuit substrate 15 is stored in the mating concave portion 72 in the vertical direction, the lighting circuit substrate 15 may be, for example, inclined obliquely as shown in FIG. 9(a) as the first modification example to increase the contact area between the lighting circuit substrate 15 and the adhesive 94. Further, as in the second modification example shown in FIG. 9(b), the lighting circuit substrate 15 may be formed smaller to be stored in the lateral direction (horizontal direction). In this case, the aperture 62b is formed on the bottom surface of the storage case 62, the protrusion 81 is formed on the bottom surface of the mating concave portion 72, and the adhesive 94 is filled between an upper surface of the laterally set lighting circuit substrate 15 and the protrusion 81 on the bottom surface of the mating concave portion 72.

Further, although surface of the protrusion 81 integrally formed on the mating concave portion 72 is formed of a plain surface, as in the third modification example shown in FIG. 9(c), convex portions 81a aligned in the vertical direction, that is, the direction to which the die is pulled, may be integrally formed to increase the contact area with the adhesive 94 which is a thermal conductive member such as silicon resin. Further, as in the fourth modification example shown in FIG. 9(d), a concave portion 81b forming a curved surface may be formed to increase the contact area.

Further, although the cap 17 is configured by the Edison type E26 model which can be attached to a socket where a general incandescent bulb can be attached, the cap may be the E17 model or the like and although the material of the whole of the cap is made of metal, the cap may be made of resin if the electrically contacting part is made of a metal such as a copper plate and the other parts are made of synthetic resin. Further, in the case of the cap having a pin-shaped terminal used for a fluorescent lamp, the cap including an L-shaped terminal used for a ceiling closet can be used.

Here, in FIG. 9 showing the above-mentioned modification examples, the same reference numerals were given to the same parts as those in the above-mentioned embodiments and detailed explanation thereof is omitted.

Preferred embodiments of the present invention have been explained above. However, the present invention is not limited to the above-mentioned embodiments and various changes and modifications may be made without departing from the spirit and scope of the invention.

What is claimed is:

1. A lamp including:
an element substrate comprising;
an element substrate main body, a plurality of light emitting elements provided at positions deviating to an outer edge side from a center position of one main surface of the element substrate main body, and
a wiring part having a connection receiving part electrically connected to the light emitting elements and a wiring hole which is formed adjacent to the connection receiving part and is penetrating via the element substrate main body which is provided in a manner that at least a part thereof overlaps the center position of the one main surface side of the element substrate main body;
a radiator having one edge side which is attached to the other main surface side of the element substrate main body of the element substrate while being in close contact with the other main surface side;
a cap attached to the other edge side of the radiator; and
a lighting device stored between the radiator and the cap which includes a power feeder and a connection part connected to a distal end of the power feeder to be connected to the connection receiving part and a power feeding part which can be inserted into the wiring hole for controlling lighting of the light emitting element.

2. The lamp according to claim 1, wherein
the radiator includes an insertion hole where the power feeder of the lighting device can be inserted at a position that corresponds to the wiring hole of the element substrate in a condition where the element substrate main body of the element substrate is attached to one edge side of the radiator.

3. The lamp according to claim 1, including a storage case which insulates the radiator and the cap, the storage case being is provided between the radiator and the cap, for storing the lighting device.

4. The lamp according to claim 3, wherein
the radiator includes the one edge part having a support part where the element substrate is provided and another edge part having a storage concave portion where the lighting device is provided,
the storage case has an aperture that communicates with the storage concave portion and is provided so as to intervene between the lighting device and the storage concave portion of the radiator, and
the radiator includes a thermal conductive member which is provided to thermally connect the lighting device and surface of the storage concave portion of the radiator via the aperture of the storage case.

5. The lamp according to claim 4, wherein
the lighting device is provided in the storage case approximately along the center axis direction of the radiator,
the storage concave portion has a protrusion protruding toward the lighting device in an integrated manner, and
the thermal conductive member connects the lighting device and the protrusion via an aperture.

6. Lighting equipment including:
an equipment main body having a socket; and
the lamp according to claim 1 with a cap which is mounted on the socket.
